(19) United States
(12) Patent Application Publication
(10) Pub. No.: US 2012/0144470 A1
(43) Pub. Date: Jun. 7, 2012

(54) USER AUTHENTICATION METHOD USING LOCATION INFORMATION

(75) Inventors: Sang-Wan KIM, Daejeon-si (KR); Joon-Kyung LEE, Daejeon-si (KR)

(73) Assignee: ELECTRONICS AND TELECOMMUNICATIONS RESEARCH INSTITUTE, Daejon (KR)

(21) Appl. No.: 13/288,371

(22) Filed: Nov. 3, 2011

(30) Foreign Application Priority Data
Nov. 29, 2010 (KR) 10-2010-0119873

(51) Int. Cl. G06F 21/00

(52) U.S. Cl. 726/7

(57) ABSTRACT

A user authentication method includes transmitting a number of the mobile communication terminal, a user identifier (ID), and a unique number (PW); at the web server, storing the number of the mobile communication terminal, the user identifier (ID), and the unique number (PW); at a mobile communication terminal registered in the web server, transmitting location information of the mobile communication terminal; at the web server, storing a table in which the location information is mapped together with the number of the mobile communication terminal, the user identifier (ID), and the unique number (PW); and when the web server receives an access request from the mobile communication terminal registered in the web server, at the web server, confirming location information of the mobile communication terminal and comparing the location information of the mobile communication terminal with the table.

### CROSS-REFERENCE TO RELATED APPLICATION

This application claims the benefit under 35 U.S.C. §119(a) of Korean Patent Application No. 10-2010-0119873, filed on Nov. 29, 2010, the disclosure of which is incorporated by reference in its entirety for all purposes.

### BACKGROUND

1. Field

The following description relates to a user authentication method for access of a mobile communication terminal to a web server, and more particularly to, a technique of performing location information-based user authentication using a mobile communication terminal with a global positioning system (GPS) function.

2. Description of the Related Art

A variety of security functions and operations can be protected by a security authentication technique. The security authentication operation for an electronic device type or a specific application usually requires each device to perform authentication on a single user. Applications such as an access system bus and interface can be activated by a user who provides specific information through which his/her identity can be confirmed. The specific information may include a password or a response to a challenge from a device.

The password is one of the most popular authentication techniques. The password is based on the user's knowledge. The user provides the password, and the device verifies the password. If it is verified that the password is associated with the user, the user's identity is authenticated. However, if it is not verified, the password is rejected, and authentication fails.

In many applications such as a security download operation, a non-authorized user may find out the password during the operation, and the password may be used to obtain access during a next operation of a similar type.

In order for the user to access to a web server or a database (DB) server, a personal identification (ID) and a password are input. A user authentication process is performed, and the user is given an access right.

Currently, the technique using the personal ID and the password is facing a limitation due to an information leakage problem, and problems have arisen in that the personal ID and the password are leaked and so important information is leaked.

That is, in order to allow a use of a terminal or system and protect data or contents, it is judged whether or not the user is an authorized user by judging whether a previously set and registered password is matched with a password input when using the terminal.

However, the technique using the password has a problem in that a meaningless password is easily forgotten, whereas a password such as one's birthday or a family member's birthday, or a telephone number is easily leaked or guessed.

Thus, there is a need for enhancing the user authentication technique using an addition authentication key at the time of user authentication of a personal portable terminal.

### SUMMARY OF THE INVENTION

According to the present invention, a location information value of a mobile communication terminal with a GPS function is additionally used for user authentication, and thus a personal authentication procedure can be enhanced.

According to the present invention, important personal information in a web server or a database (DB) server can be protected.

According to the present invention, the mobile communication terminal has an owner's unique number. A unique terminal number and a location information value that are transmitted from the unique terminal are registered in association with a server access user's identification (ID). The registered location information value may be used as user authentication information in addition to the ID and the password.

According to the present invention, since the location information value of the mobile communication terminal changes from time to time, each time the user registers the location information, an authentication key value changes. Thus, a security effect can be maximized compared to a case of using a fixed authentication number.

According to the present invention, since the location information value of the mobile communication terminal that is always carried by the user is used as an authentication key, a risk in which the authentication key is lost or broken due to the user's carelessness can be reduced.

According to the present invention, when the location information is changed and registered, a change confirmation message is transmitted to the mobile communication terminal. When another person who illegally steals personal information other than the authorized user makes an attempt to access, the user can recognize an illegal access situation in real time and take measures.

According to an exemplary aspect, there is provided a user authentication method using location information for access of a mobile communication to a web server which includes: at the mobile communication terminal, transmitting a number of the mobile communication terminal, a user identifier (ID), and a unique number (PW); at the web server, storing the number of the mobile communication terminal, the user identifier (ID), and the unique number (PW); at a mobile communication terminal registered in the web server, transmitting location information of the mobile communication terminal; at the web server, storing a table in which the location information is mapped together with the number of the mobile communication terminal, the user identifier (ID), and the unique number (PW); and when the web server receives an access request from the mobile communication terminal registered in the web server, at the web server, confirming location information of the mobile communication terminal and comparing the location information of the mobile communication terminal with the table.

The user authentication method using location information may further include, at the web server, transmitting a message informing that the table has been stored in the mobile communication terminal.

The transmitting of the location information of the mobile communication terminal may include acquiring a location information value based on a global positioning system (GPS) of the mobile communication terminal and transmitting the location information value, or receiving a location information value directly from a user of the mobile communication terminal and transmitting the location information value.

In the storing of the table in which the location information is mapped, as the location information, location information storing a table in which at least one location information value acquired based on the GPS of the mobile communication terminal or at least one location information value input directly from the user of the mobile communication terminal is received and mapped may be used.

The comparing of the location information of the mobile communication terminal with the table may include: at the mobile communication terminal, requesting the web server to perform first access authentication using the number of the mobile communication terminal, the user identifier (ID), and the unique number (PW); at the web server, performing the first access authentication based on the number of the mobile communication terminal, the user identifier (ID), and the unique number (PW) with reference to the table and requesting the mobile communication terminal to transmit the location information; at the mobile communication terminal, transmitting the location information of the mobile communication terminal to the web server; and at the web server, comparing the received location information with the table and performing second access authentication on the mobile communication terminal when the location information is matched with the location information in the table.

In the requesting of the mobile communication terminal to transmit the location information, the location information for performing the first access authentication when the number of the mobile communication terminal, the user identifier (ID), and the unique number (PW) are matched with information in the table may be used.

The transmitting of the location information of the mobile communication terminal may include acquiring a location information value based on a global positioning system (GPS) of the mobile communication terminal and transmitting the location information value, or receiving a location information value directly from a user of the mobile communication terminal and transmitting the location information value.

In the performing of the second access authentication, when a location information value acquired based on a GPS of the mobile communication terminal or a location information value input directly from a user of the mobile communication terminal is matched with information in the table, location information for performing the second access authentication so that a service is provided from the web server may be used.

The user authentication method using location information may further include, at the web server, transmitting a message informing the mobile communication terminal of that the second access authentication has been performed to the mobile communication terminal.

The user authentication method using location information may further include: at a user of the mobile communication terminal, requesting the web server to release access authentication of the mobile communication terminal when the received message is transmitted due to illegal access; and at the web server that is requested to release, releasing the first access authentication and the second access authentication on the mobile communication terminal.

The mobile communication terminal has an owner's unique number. A unique terminal number and a location information value that are transmitted from the unique terminal are registered in association with a server access user's identification (ID). The registered location information value may be used as user authentication information in addition to the ID and the password.

Further, even if an accident that the ID and the password are leaked happens, when the user access the server, the registered location information value is used as a key for additional user authentication, and thus important information leakage is prevented, and security can be enforced.

Since the location information value of the mobile communication terminal changes from time to time, each time the user registers the location information, an authentication key value changes. Thus, a security effect can be maximized compared to a case of using a fixed authentication number.

Since the location information value of the mobile communication terminal that is always carried by the user is used as an authentication key, a risk in which the authentication key is lost or broken due to the user's carelessness can be reduced.

When the location information is changed and registered, a change confirmation message is transmitted to the mobile communication terminal. When another person who illegally steals personal information other than the authorized user makes an attempt to access, the user can recognize an illegal access situation in real time and take measure.

Other objects, features and advantages will be apparent from the following description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain aspects of the invention.

FIG. 1 is a block diagram illustrating a user authentication system that performs user authentication using location information according to an exemplary embodiment of the present invention;

FIG. 2 is a diagram illustrating a process (I) of performing user authentication using location information according to an exemplary embodiment of the present invention; and

FIG. 3 is a diagram illustrating a process (II) of performing user authentication using location information according to an exemplary embodiment of the present invention.

Elements, features, and structures are denoted by the same reference numerals throughout the drawings and the detailed description, and the size and proportions of some elements may be exaggerated in the drawings for clarity and convenience.

### DETAILED DESCRIPTION OF EMBODIMENTS

The detailed description is provided to assist the reader in gaining a comprehensive understanding of the methods, apparatuses and/or systems described herein. Various changes, modifications, and equivalents of the systems, apparatuses, and/or methods described herein will likely suggest themselves to those of ordinary skill in the art. Also, descriptions of well-known functions and constructions are omitted to increase clarity and conciseness.

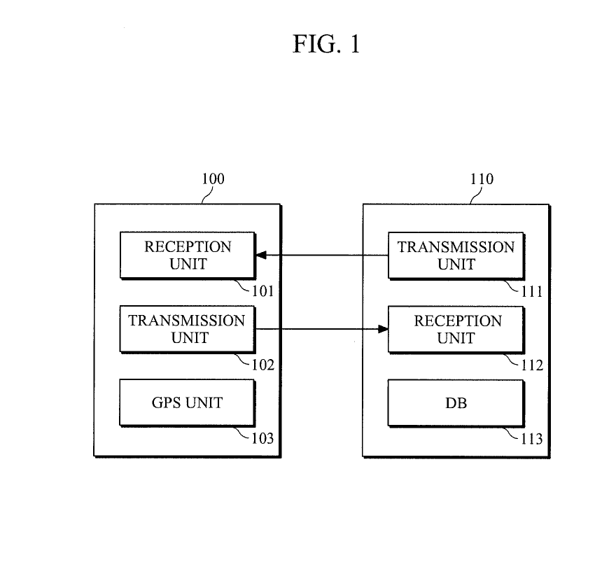

FIG. 1 is a block diagram illustrating a user authentication system that performs user authentication using location information according to an exemplary embodiment of the present invention. Referring to FIG. 1, the user authentication system of the present invention may include a mobile communication terminal 100 and a web server 110.

The mobile communication system 100 may be configured to include a reception unit 101, a transmission unit 102, and a GPS unit 103.

The web server 110 may be configured to include a transmission unit 111, a reception unit 112, and a DB 113.

The reception unit 101 of the mobile communication terminal 100 is connected with the transmission unit 111 of the web server 110 to perform communication, and the transmission unit 102 of the mobile communication terminal 100 is connected with the reception unit 112 of the web server 110 to perform communication.

Through the above communication process, the mobile communication terminal 100 may transmit GPS-based location information acquired by the GPS unit 103 to the web server 110 and receive request information stored in the DB 113 from the web server 110.

In order for a user of the mobile communication terminal 100 to acquire necessary information, user or terminal authentication should be performed in the web server 110. In the present invention, not only user authentication based on a personal identifier (ID) and a unique number (password) but also authentication based on location information are performed.

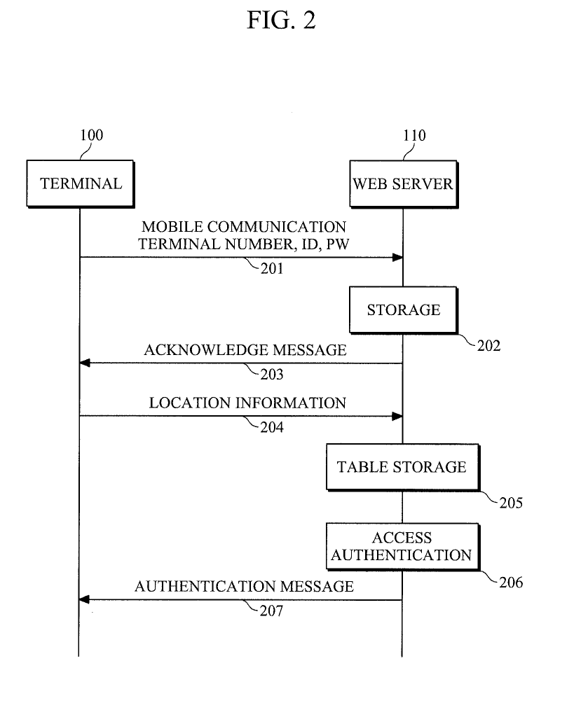

FIG. 2 is a diagram illustrating a process (I) of performing user authentication using location information according to an exemplary embodiment of the present invention. The user authentication process (I) of the present invention includes information transmission and reception between the terminal 100 and the web server 100 and an information processing procedure in the web server 110.

First, the mobile communication terminal 100 transmits a mobile communication terminal number, the user identifier (ID), and the unique number (PW) to the web server 110 (step 201).

Next, the web server 110 stores the mobile communication terminal number, the user identifier (ID), and the unique number (PW) that are received from the mobile communication terminal 100 (step 202). After the information is stored in the web server 110, an acknowledge message is transmitted to the mobile communication terminal 100 (step 203), and the user can recognize that an authentication process is being performed in the web server 110.

Subsequently, the mobile communication terminal 100 registered in the web server 110 transmits the location of the mobile communication terminal 100 in the form of a GPS-based location information value (204). The web server 110 configures a table by mapping the location information value together with the mobile communication terminal number, the user identifier (ID), and the unique number (PW) and stores the table (step 205).

Thereafter, when the mobile communication terminal 100 that has transmitted the location information value is the mobile communication terminal 100 registered in the web server 110 and the access request is received from the mobile communication terminal 100, the web server 100 compares the location information of the mobile communication terminal 100 with the table. When the location information of the mobile communication terminal 100 is confirmed by the table, the web server 110 performs access authentication on the mobile communication terminal 100 (step 206).

When the web server 110 completes access authentication, the mobile communication terminal 100 can freely use services provided by the web server 110.

When access authentication is completed, the web server 110 transmits an authentication result message to the mobile communication terminal 100 (step 207). Through the message, the user of the mobile communication terminal 100 can confirm that access to the web server 110 has been completed.

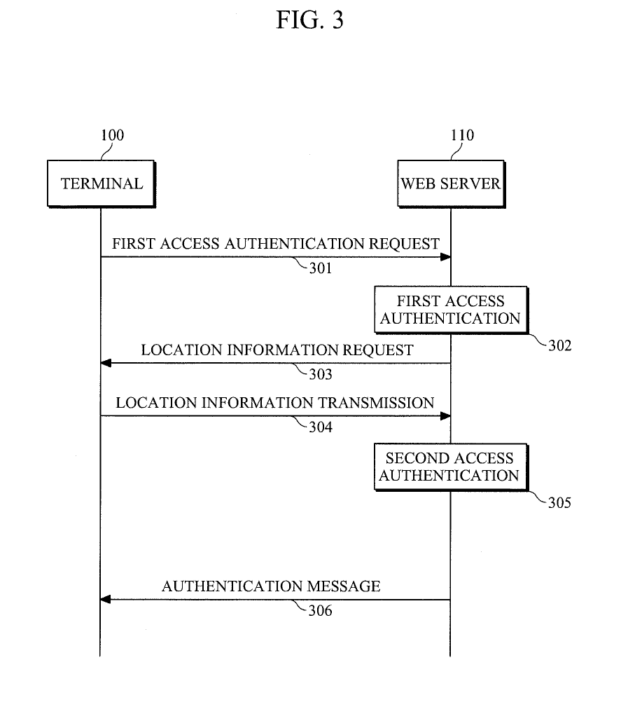

FIG. 3 is a diagram illustrating a process (II) of performing user authentication using location information according to an exemplary embodiment of the present invention. The user authentication process (II) of the present invention also includes information transmission and reception between the terminal 100 and the web server 100 and an information processing procedure in the web server 110.

In the user authentication process (II), it is assumed that during a user registration procedure in which an authorized user who uses the mobile communication terminal 100 registers his/her mobile communication terminal number in the web server 110 that he/she desires to access, the location information of the mobile communication terminal 100 is mapped with the personal ID and the password in the form of the table.

First, the mobile communication terminal 100 requests the web server 110 to perform first access authentication using the mobile terminal number, the user identifier (ID), and the unique number (password) (step 301).

The web server 110 perform first access authentication based on the mobile terminal number, the user identifier (ID), and the unique number with reference to the table stored therein (step 302) and requests the mobile communication terminal 100 to transmit the location information (step 303).

In order to access the web server 110, the location information value on the current location is transmitted to the web server 110 together with the user mobile communication terminal number through the registered mobile communication terminal 100 (step 304). At this time, the user may manually transmit the user mobile communication terminal number and the location information value to the web server 110. The transmission of the location information value may be variously implemented. For example, dedicated software for transmitting the location information value may be installed in the mobile communication terminal, and the location information may be transmitted to the web server 110 by the dedicated software.

The web server 110 compares the received location information value with the table. When the received location information value is matched with the location information in the table, the web server 110 performs second access authentication on the mobile communication terminal 100 (step 305).

When second access authentication is completed, a message informing that access authentication has normally been completed is transmitted to the user communication terminal 100 (step 306). Through the message, the user of the mobile communication terminal 100 can confirm that access to the web server 110 has been completed.

The user who illegally steals the personal ID and the password and then makes an attempt to access the corresponding server cannot know a registered location information authentication key value and thus cannot complete the authentication process. Thus, access to the server can fundamentally be blocked.

Further, even when the illegal user copies the authorized user's mobile communication terminal 100 and then makes an attempt to access the web server 110, since the message informing that the change in registration of the location information has been performed is transmitted to the authorized user's mobile communication terminal 100, the authorized user can recognize that his/her personal ID and password have been stolen and an attempt to illegally access is being made and thus take measures.

Meanwhile, the exemplary embodiments of the present invention can be embodied as computer-readable codes on a computer-readable recording medium. The codes and code segments for complementing the program can be easily deduce by computer programmers skilled in the art. The computer-readable recording medium includes all kinds of recording devices storing data that is readable by a computer system. Examples of the computer-readable recording medium include read-only memories (ROMs), random-access memories (RAMS), compact disc (CD)-ROMs, magnetic tapes, floppy disks, and optical disks. The computer-readable recording medium can be distributed over network connected computer systems so that the computer-readable code is stored and executed in a distributed fashion.

It will be apparent to those of ordinary skill in the art that various modifications can be made to the exemplary embodiments of the invention described above. However, as long as modifications fall within the scope of the appended claims and their equivalents, they should not be misconstrued as a departure from the scope of the invention itself.

What is claimed is:

1. A user authentication method using location information for access of a mobile communication to a web server, the method comprising:
at the mobile communication terminal, transmitting a number of the mobile communication terminal, a user identifier (ID), and a unique number (PW);
at the web server, storing the number of the mobile communication terminal, the user identifier (ID), and the unique number (PW);
at a mobile communication terminal registered in the web server, transmitting location information of the mobile communication terminal;
at the web server, storing a table in which the location information is mapped together with the number of the mobile communication terminal, the user identifier (ID), and the unique number (PW); and
when the web server receives an access request from the mobile communication terminal registered in the web server, at the web server, confirming location information of the mobile communication terminal and comparing the location information of the mobile communication terminal with the table.

2. The user authentication method using location information according to claim 1, further comprising, at the web server, transmitting a message informing that the table has been stored in the mobile communication terminal.

3. The user authentication method using location information according to claim 1, wherein the transmitting of the location information of the mobile communication terminal comprises
acquiring a location information value based on a global positioning system (GPS) of the mobile communication terminal and transmitting the location information value, or
receiving a location information value directly from a user of the mobile communication terminal and transmitting the location information value.

4. The user authentication method using location information according to claim 1, wherein in the storing of the table in which the location information is mapped,
as the location information, location information storing a table in which at least one location information value acquired based on the GPS of the mobile communication terminal or at least one location information value input directly from the user of the mobile communication terminal is received and mapped is used.

5. The user authentication method using location information according to claim 1, wherein the comparing of the location information of the mobile communication terminal with the table comprises:
at the mobile communication terminal, requesting the web server to perform first access authentication using the number of the mobile communication terminal, the user identifier (ID), and the unique number (PW);
at the web server, performing the first access authentication based on the number of the mobile communication terminal, the user identifier (ID), and the unique number (PW) with reference to the table and requesting the mobile communication terminal to transmit the location information;
at the mobile communication terminal, transmitting the location information of the mobile communication terminal to the web server; and
at the web server, comparing the received location information with the table and performing second access authentication on the mobile communication terminal when the location information is matched with the location information in the table.

6. The user authentication method using location information according to claim 5, wherein in the requesting of the mobile communication terminal to transmit the location information, the location information for performing the first access authentication when the number of the mobile communication terminal, the user identifier (ID), and the unique number (PW) are matched with information in the table is used.

7. The user authentication method using location information according to claim 5, wherein the transmitting of the location information of the mobile communication terminal comprises
acquiring a location information value based on a global positioning system (GPS) of the mobile communication terminal and transmitting the location information value, or
receiving a location information value directly from a user of the mobile communication terminal and transmitting the location information value.

8. The user authentication method using location information according to claim 5, wherein, in the performing of the second access authentication,
when a location information value acquired based on a GPS of the mobile communication terminal or a location information value input directly from a user of the mobile communication terminal is matched with information in the table, location information for performing the second access authentication so that a service is provided from the web server is used.

9. The user authentication method using location information according to claim 1, further comprising, at the web server, transmitting a message informing the mobile communication terminal that the second access authentication has been performed to the mobile communication terminal.

10. The user authentication method using location information according to claim 9, further comprising:
by a user of the mobile communication terminal, requesting the web server to release access authentication of the mobile communication terminal when the received message is transmitted due to illegal access; and
at the web server that is requested to release, releasing the first access authentication and the second access authentication on the mobile communication terminal.
